(19) United States
(12) Patent Application Publication
(10) Pub. No.: US 2004/0179770 A1
(43) Pub. Date: Sep. 16, 2004

(54) Polarisation independent optical switch

(75) Inventor: Ian Charles Sage, Malvern (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: QinetiQ Limited

(21) Appl. No.: 10/794,350

(22) Filed: Mar. 5, 2004

(30) Foreign Application Priority Data
Mar. 14, 2003 (GB) 0305858.3

(51) Int. Cl. G02B 6/26

(52) U.S. Cl. 385/16

(57) ABSTRACT

A polarisation independent optical switch comprises a dielectric layer (6) in which are formed a multiplicity of minute channels (7). These channels (7) are instilled with a liquid crystal fluid, especially a nematic liquid crystal (8). Electrodes (4, 5) are formed on each side of the dielectric layer between two cell walls (2, 3). Application of a voltage across the layer results in an effective change of the refractive index of the layer, and therefore modulates the phase of light traversing the layer (6).

This invention relates to a polarisation independent optical switch incorporating a liquid crystal material and operable over a wide range of optical and near optical wavelengths.

In many applications it is desirable to switch light without regard to its polarisation state. In conventional liquid crystal devices the polarisation state is fixed by polarisers and/or phase plates attached to the cell. Such layers add cost and are wasteful of light. For many applications they represent an unacceptable optical loss. A polarisation independent switch has been described which uses a liquid crystal layer in combination with a quarter wave plate. The resulting device provides phase modulation of incoming light but is effective only at a single wavelength and is difficult to fabricate. Micromechanical devices can provide polarisation independent phase modulation, but are costly, difficult to fabricate, often unreliable and require large capital investment. A liquid crystal/polymer composite termed nanodroplet PDLC can provide a polarisation independent switch, but is difficult to fabricate and requires very high operating voltages.

The present invention overcomes the above problems and achieves polarisation independent phase modulation of light at all wavelengths from a simple, inexpensive and robust device.

According to this invention a polarisation independent optical switch comprises a dielectric layer in which are formed a multiplicity of minute channels. These channels are instilled with a liquid crystal fluid, especially a nematic liquid crystal. Electrodes are formed on each side of the dielectric layer; application of a voltage across the layer results in an effective change of the refractive index of the layer, and therefore modulates the phase of light traversing the layer.

According to this invention a polarisation independent optical switch comprises:

a dielectric layer held between two cell walls bearing electrode structures for applying an electric field across the dielectric layer,

the dielectric layer having formed therein a multiplicity of minute channels containing a liquid crystal material.

The dielectric layer thickness may be between 2 and 4000 μm, typically in the range 10 to 250 microns.

The liquid crystal material is preferably a nematic material, of either positive or negative dielectric anisotropy. It is well understood by those skilled in the art, how to combine the surface alignment, dielectric anisotropy and electrode disposition in order to maximise the desired effect.

Cholesteric or smectic liquid crystals may also be used. In the case of ferroelectric smectic liquid crystals, switching fields may exploit the dielectric anisotropy, the spontaneous polarisation, or both.

The switch may operate either in transmission or reflection, in the latter case a full or partially reflecting mirror may be incorporated inside the walls.

Preferably the channels are smaller that the wavelength of the light to be used, in at least one dimension. Preferably the channels are formed substantially normal to the plane of the dielectric layer. Preferably the channels are present at a substantially uniform density over a useful area of the device. Preferably the channels in total comprise a significant fraction (for example, greater than 5%) of the total volume of the layer. Preferably the channels are substantially uniform in size, spacing and cross section. Preferably the channels are substantially isolated from one another.

Suitable channels may be formed by known means, for example by lithography and anisotropic etching of a silicon dielectric, or by anodisation of aluminium. Anodisation of aluminium is a particularly preferred embodiment of this process, as it provides a route to large areas of uniform channel-structured dielectric aluminium oxide, at very low cost. Anodisation of other metals and alloys may also be used, along with micro machining, lithography etc. Preferably if anodisation is used, it is performed under conditions which lead to an ordered array of minute channels of substantially unform size and density oriented substantially normal to the dielectric layer plane.

An anodised aluminium oxide layer may be used on a residual metal layer as reflective substrate. Alternatively the anodisation may be continued to remove all the aluminium and expose a lower, unreactive metal which may serve as reflector and electrode. Alternatively the anodised oxide layer may be transferred to another substrate by known means.

Anodised layers may be formed by known means, such as by electrochemical anodisation in cold oxalic acid solution or phosphoric acid solution. The metal layer may be formed of bulk metal such as aluminium sheet or foil, or may be deposited as a layer on a support by evaporation or sputtering. The oxide layer after anodisation may be separated from residual bulk metal by known means including etching of the metal with acid or with bromine solution.

Preferably the channels formed in the dielectric layer are open at least one end to facilitate filling with liquid crystal. Liquid crystal filling may be performed by known means, e.g. by placing the layer with channels in vacuum and immersing in liquid crystal. The dielectric layer with LC filled channels is furnished with electrodes by known means including but not limited to evaporation of metals, sputtering of metals or transparent conductors such as indium tin oxide, solution deposition of conductors such as poly(aniline) or poly(dioxanyl thiophene) in their doped, conducting states, and lamination with a substrate having significant conductivity.

Under an applied voltage, the liquid crystal director distorts, changing its effective refractive index and providing phase modulation. Said phase modulation may be exploited to provide switchable diffraction and beam steering, or by inclusion of the device in an optically resonant cavity, a switchable notch filter or bandpass filter may be obtained. Other applications will be evident.

The interior of the channels may be modified in known ways to control the alignment of liquid crystals introduced into them. For example, dilute solutions of certain polymers or surfactants may be introduced and the solvent subsequently removed, resulting in respectively parallel or perpendicular alignment of the liquid crystal director at the channel walls. The overall configuration of the liquid crystal within each channel is determined by a balance of surface, bulk elastic and dielectric forces, according to known principles. Examples of suitable polymers or surfactants include lecithin, hexadecyltrimethyl ammonium bromide, basic chromium (III) stearato chloride and poly(imide).

In some configurations, the liquid crystal in the channels is subject to strong director curvature. In this case the flexoelectric effects may be exploited to provide switching. Analogously with electrical switching, it is understood that magnetic fields may be applied to provide switching of the device, or to bias the operating point of a device.

One form of the invention will now be described, by way of example only, with reference to the accompanying drawings in which:

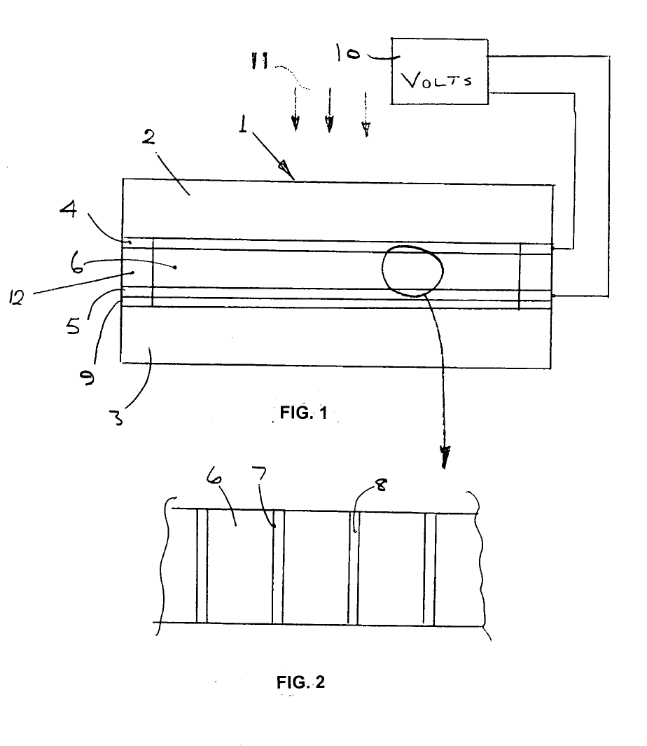

FIG. 1 is a cross sectional view of a liquid crystal cell forming an optical switch;

FIG. 2 is an enlarged view of part of the cell of FIG. 1.

As seen in the Figures, a switch 1 comprises two cell walls 2, 3 carrying electrode structures 4, 5. The walls may be of transparent glass and hold a thin layer 6 of a dielectric material such as silicon or anodised aluminium. The layer 6 has formed therein a multiplicity of minute channels 7 containing a nematic liquid crystal material 8. Prior to assembly the channels may be surface treated to give a desired surface alignment to liquid crystal material. For example the channels may be filled with a dilute surfactant such as hexadecyltrimethyl ammonium bromide and the solvent removed to leave a surfactant coating. A reflector 9 is arranged on the inside of wall 2, and may be a separate layer as shown, or be the reflective surface of an electrode.

Voltages are applied to the electrodes 4, 5 from a voltage source 10.

Light 11 to be modulated is directed through the upper wall 3, through the liquid crystal material 8 to the reflector 9, back through the liquid crystal material and wall 3. Depending upon the applied electric field the liquid crystal director distorts changing its effective refractive index and providing phase modulation. Such modulation is independent of the state of polarisation (if any) of incident light 11.

A second, partial, reflector may be arranged on the inner face of wall 2 to form a resonant cavity and provide a switchable notch filter or bandpass filter.

The cell walls 2, 3 are shown as relatively thick self-supporting structures separated by a spacer ring 12. In another embodiment, one wall is a self-supporting substrate and the other wall is a thin protective layer. At least one of the walls is optically transparent.

1. A polarisation independent optical switch comprising:
a dielectric layer held between two cell walls bearing electrode structures for applying an electric field across the dielectric layer,
the dielectric layer having formed therein a multiplicity of minute channels containing a liquid crystal material.

2. The switch of claim 1 wherein the dielectric layer thickness is between 2 and 4000 μm,

3. The switch of claim 1 wherein the dielectric layer thickness is between 10 and 250 μm,

4. The switch of claim 1 wherein the layer is an etched layer of silicon.

5. The switch of claim 1 wherein the layer is a layer of anodised aluminium.

6. The switch of claim 1 wherein the layer is a layer of anodised titanium

7. The switch of claim 1 wherein the liquid crystal material is a nematic material

8. The switch of claim 1 wherein the liquid crystal material is a smectic material.

9. The switch of claim 1 and further including a reflector.

10. The switch of claim 1 wherein the channels are smaller that the wavelength of the light to be used, in at least one dimension.

11. The switch of claim 1 wherein the channels are formed substantially normal to the plane of the dielectric layer.

12. The switch of claim 1 wherein the channels are present at a substantially uniform density over a useful area of the layer.

13. The switch of claim 1 wherein the channels in total comprise a fraction greater than 5% of the total volume of the layer.

14. The switch of claim 1 wherein the channels are substantially uniform in size, spacing and cross section.

15. The switch of claim 1 wherein the channels are substantially isolated from one another.

16. The switch of claim 1 wherein one cell wall is a supporting substrate and the other wall is a thin protective layer.

17. The switch of claim 1 wherein at least one cell wall is optically transparent.
